(19) United States
(12) Patent Application Publication
(10) Pub. No.: US 2016/0253144 A1
(43) Pub. Date: Sep. 1, 2016

(54) DISPLAY CONTROL SYSTEM AND METHOD FOR DISPLAY DEVICE

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: HUNG-CHI HUANG, New Taipei (TW)

(21) Appl. No.: 14/794,127

(22) Filed: Jul. 8, 2015

(30) Foreign Application Priority Data
Feb. 26, 2015 (TW) 104106181

(51) Int. Cl. G06F 3/14; H04W 4/00; G06F 3/16; G06F 3/023; G06F 3/041; G06F 3/0354

(52) U.S. Cl. CPC G06F 3/1462; G06F 3/0412; G06F 3/03543; G06F 3/1423; G06F 3/167; G06F 3/023; H04W 4/008

(57) ABSTRACT

A display control system for a display device includes a display module, a switch module, and a processor module. The display module generates a first image. The switch module switches to a first switch signal or a second switch signal according to user input instructions. The processor module receives the switch signal sent from the switch module. When the processor module receives the first switch signal, the processor module outputs the first image to a display. When the processor module receives the second switch signal, the processor module outputs the first image to the display, and the processor module further outputs a second image to a screen.

### FIELD

The subject matter herein generally relates to display technology, and particularly to a display control system and a method for a display device.

### BACKGROUND

A display may be connected to an electronic device (e.g., a smart phone) for displaying images from the electronic device.

### BRIEF DESCRIPTION OF THE DRAWINGS

Implementations of the present technology will now be described, by way of example only, with reference to the attached figures.

FIG. 1 is a block diagram of an exemplary embodiment of a display control system for a display device.

FIG. 2 is a block diagram of an exemplary embodiment of a processor of FIG. 1.

FIG. 3 is a diagrammatic view of an exemplary embodiment of the display control system being wirelessly connected to a keyboard.

FIG. 4 is a diagrammatic view of an exemplary embodiment of the display control system being wirelessly connected to a mouse.

FIG. 5 is a diagrammatic view of an exemplary embodiment of the display control system.

FIG. 6 is a flowchart of an example embodiment of a display control method for a display device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently coupled or releasably coupled. The term “comprising” means “including, but not necessarily limited to”; it specifically indicates open-ended inclusion or membership in a so-described combination, group, series, and the like. The term “module” refers to logic embodied in hardware or firmware, or to a collection of software instructions, written in a programming language, such as, Java, C, or assembly.

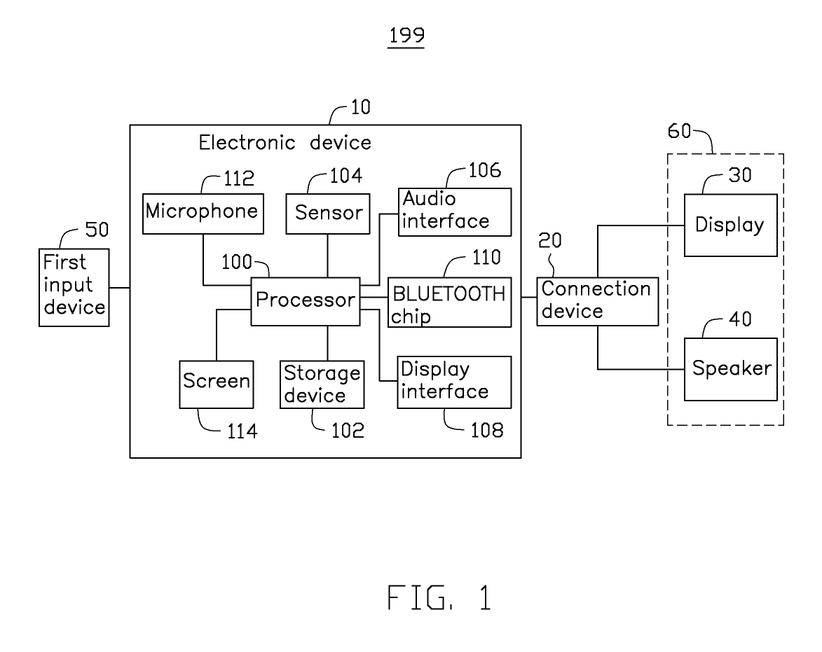

FIG. 1 illustrates an embodiment of a display control system 199 that includes an electronic device 10, a connection device 20, a display device 60 coupled to the electronic device 10 via the connection device 20, and a first input device 50 coupled to the electronic device 10. A user can input instructions to the electronic device 10 via the input device 50. The electronic device 10 can be a smart phone, a tablet computer, a laptop, a personal computer, or any other suitable electronic device. The connection device 20 can be a wired or a wireless device. For example, the display device 60 is coupled to the electronic device 10 via a transmission line, or the display device 60 is wirelessly coupled to the electronic device 10 via a wireless device.

The electronic device 10 includes a microphone 112, a sensor 104, a screen 114, a storage device 102, an audio interface 106, a BLUETOOTH chip 110, a display interface 108, and a processor 100 coupled to the microphone 112, the sensor 104, the screen 114, the storage device 102, the audio interface 106, the BLUETOOTH chip 110, and the display interface 108. The display device 60 includes a display 30 and a speaker 40. The display 30 stores various display parameters, such as resolution, display size, and portrait and landscape scales.

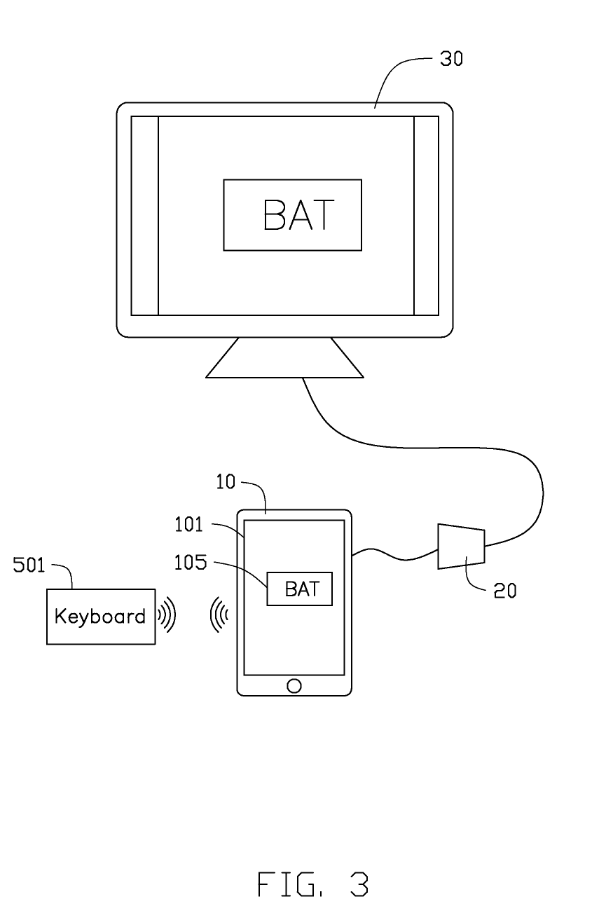

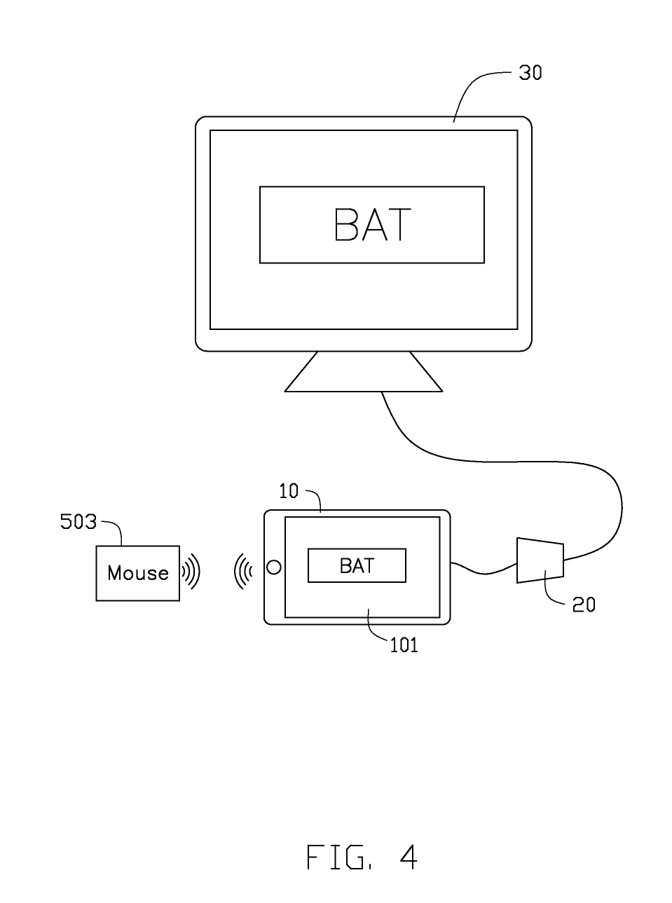

The sensor 104 detects a display state signal of a display state of the electronic device 10 and transmits the display state signal to the processor 100. The display state of the electronic device 10 can be a portrait display state (FIG. 3) or a landscape display state (FIG. 4).

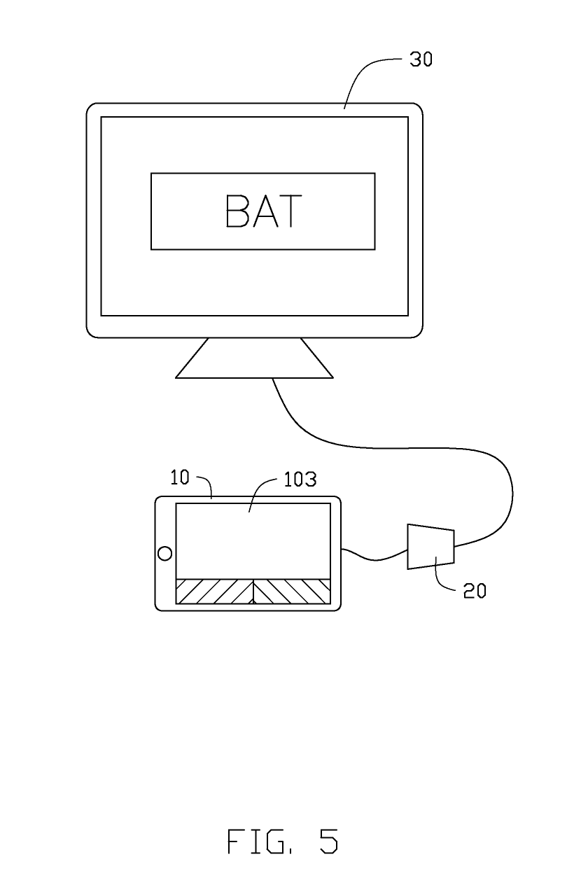

The microphone 112 receives a voice signal from the user and transmits the voice signal to the processor 100. Work modes of the electronic device 10 can be controlled by the user via the microphone 112. The work modes include a mirror mode and an extension mode. FIGS. 3-4 illustrate that the screen 114 of the electronic device 10 displays a first image 101. FIG. 5 illustrates that the screen 114 of the electronic device 10 displays a second image 103. The screen 114 is a touch screen. The first image 101 includes an operation system interface and an application program interface, for example, browser interface. The second image 103 includes a touch pad interface, a mouse interface, and a keyboard interface. The electronic device 10 displays the first image 101 and transmits the first image 101 to the display device 60 via the display interface 108 when the electronic device 10 operates in the mirror mode. The electronic device 10 displays the second image 103 and transmits the first image 101 to the display device 60 via the display interface 108 when the electronic device 10 operates in the extension mode. The electronic device 10 transmits audio signals of the first image 101 and the second image 103 to the speaker 40 of the display device 60 via the audio interface 106.

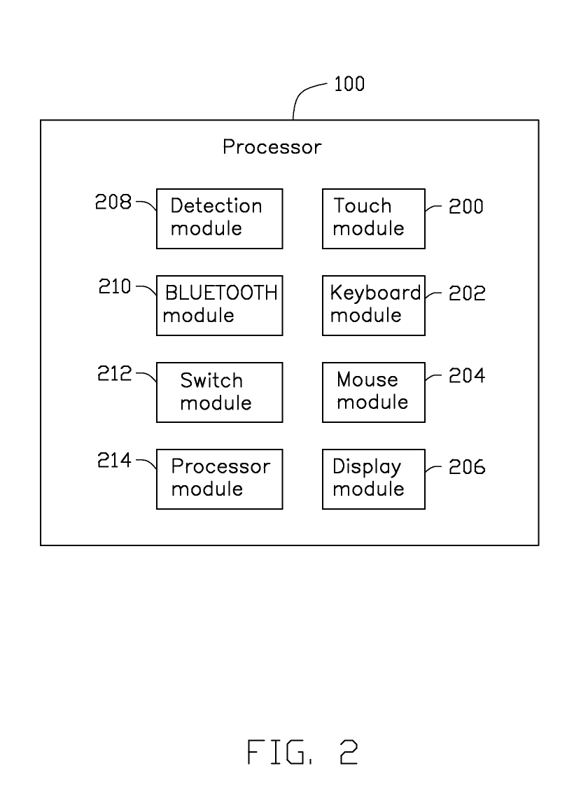

FIG. 2 illustrates that the processor 100 includes a display module 206, a switch module 212, a detection module 208, a BLUETOOTH module 210, a touch module 200, a keyboard module 202, a mouse module 204, and a processor module 214.

In the illustrated embodiment, the detection module 208 detects the display parameters of the display device 60 via the connection device 20 and transmits the display parameters to the processor module 214. The detection module 208 further detects the display state signal transmitted from the sensor 104 and transmits the display state signal to the processor module 214.

The switch module 212 switches to a first switch signal or a second switch signal according to the voice signals from the user via the microphone 112. The mirror mode or the extension mode of the electronic device 10 can be controlled according to the first switch signal or the second switch signal. For example, when the switch module 212 switches to the first switch signal, the electronic device 10 operates in the mirror mode. When the switch module 212 switches to the second switch signal, the electronic device 10 operates in the extension mode. In other embodiments, the switch module 212 switches to the first switch signal or the second switch signal according to the user instructions input through any other suitable input device.

The processor module 214 can receive the switch signal sent from the switch module 212 and output the image generated from the display module 206 to the display 30 via the display interface 108. For example, when the processor module 214 receives the first switch signal, the processor module 214 outputs the first image 101 generated from the display module 206 to the display 30 via the display interface 108. When the processor module 214 receives the second switch signal, the processor module 214 outputs the first image 101 generated from the display module 206 to the display 30 via the display interface 108, and the processor module 214 outputs the second image 103 generated from the display module 206 to the screen 114 via the display interface 108. The first image 101 can be operated by the user via the second image 103 (for example, a touch pad interface, a mouse interface, or a keyboard interface).

In the illustrated embodiment, the processor module 214 can further adjust properties, for example, size of the first image 101 according to the display parameters of the display 30 via the detection module 208. For example, the processor module 214 enlarges the first image 101 to cover a whole display area of the display 30.

In the illustrated embodiment, the processor module 214 can further adjust properties, for example, direction of the first image 101 according to the display state of the electronic device 10 via the sensor 104. For example, when the electronic device 10 is in the portrait display state (FIG. 3), the processor module 214 adjusts the first image 101 to the portrait display state. When the electronic device 10 is in the landscape display state (FIG. 4), the processor module 214 adjusts the first image 101 to the landscape display state.

The processor module 214 communicates with the first input device 50 via the BLUETOOTH module 210. In the illustrated embodiment, the first input device 50 can be a keyboard 501, a mouse 503, or a touch pad. The keyboard 501, the mouse 503, or the touch pad transmit different wireless signals which can be directly received by the electronic device 10 via the BLUETOOTH module 210.

The BLUETOOTH module 210 determines whether the wireless signal includes a first instruction signal from the keyboard 501 of the first input device 50. If the wireless signal includes a first instruction signal from the keyboard 501, the BLUETOOTH module 210 outputs the first instruction signal to the keyboard module 202 of the processor 100, and the keyboard module 202 generates a first operation signal. The BLUETOOTH module 210 determines whether the wireless signal includes a second instruction signal from the touch pad of the first input device 50. If the wireless signal includes a second instruction signal from the touch pad, the BLUETOOTH module 210 outputs the second instruction signal to the touch module 200 of the processor 100, and the touch module 200 generates a second operation signal. The BLUETOOTH module 210 determines whether the wireless signal includes a third instruction signal from the mouse 503 of the first input device 50. If the wireless signal includes a third instruction signal from the mouse 503, the BLUETOOTH module 210 outputs the third instruction signal to the mouse module 204 of the processor 100, and the mouse module 204 generates a third operation signal.

The processor module 214 receives the first operation signal, the second operation signal, or the third operation signal and generates a first control signal. The user can input instructions to the electronic device 10 via the first input device 50 according to the first control signal from the processor module 214 of the processor 100.

For example, when the electronic device 10 operates in the mirror mode (FIG. 3 and FIG. 4), the processor module 214 adjusts the first image 101 according to the display parameters of the display 30 and outputs the adjusted first image 101 from the processor module 214 to the display 30. Accordingly, if the processor module 214 receives the first operation signal from the keyboard module 202, an input frame 105 of the electronic device 10 can be input by the user via the keyboard 501 of the first input device 50. If the processor module 214 receives the second operation signal from the touch module 200, the input frame 105 of the electronic device 10 can be input by the user via the touch pad of the first input device 50. If the processor module 214 receives the third operation signal from the mouse module 204, the input frame 105 of the electronic device 10 can be input by the user via the mouse 503 of the first input device 50.

When the electronic device 10 operates in the extension mode (FIG. 5), the processor module 214 adjusts the first image 101 according to the display parameters of the display 30 and outputs the adjusted first image 101 from the processor module 214 to the display 30. The processor module 214 further outputs the second image 103 generated from the display module 206 to the screen 114 via the display interface 108. The first image 101 can be operated by the user via the second image 103 (for example, the touch pad interface, the mouse interface, or the keyboard interface). Accordingly, the electronic device 10 can be a second input device. For example, if the second image 103 is the touch pad interface, the touch pad interface of the electronic device 10 can be input by the user via the electronic device 10. The detection module 208 detects a touch signal input by the user via the touch pad interface of the electronic device 10 and transmits a second control signal to the processor module 214. The processor module 214 receives the second control signal and executes the second control signal. Therefore, the user can input the instructions to the first image 101 displayed on the display device 60 via the touch pad interface according to the second control signal from the detection module 208 of the processor 100.

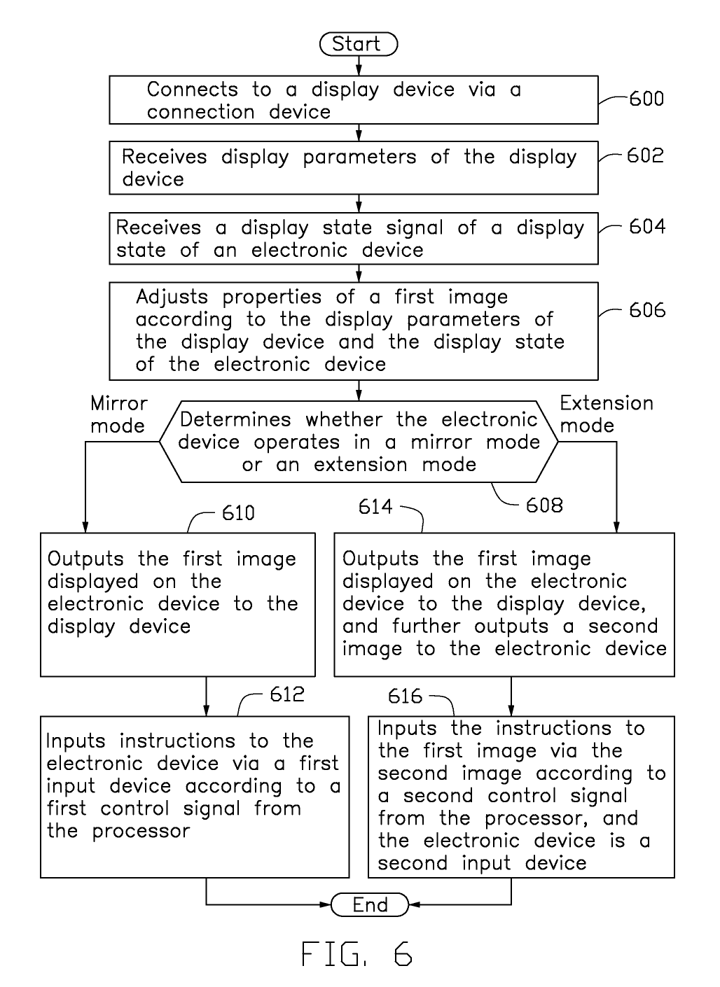

Referring to FIG. 6, a flowchart is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining method. Each block shown in FIG. 6 represents one or more processes, methods, or subroutines, carried out in the exemplary method. Furthermore, the illustrated order of blocks is by example only and the order of the blocks can change according to the present disclosure. Additional blocks can be added or fewer blocks can be utilized, without departing from this disclosure. The example method can begin at block 600.

At block 600, an electronic device connects to a display device via a connection device.

At block 602, a processor receives display parameters of the display device. In the illustrated embodiment, a processor module of the processor receives the display parameters of the display device via the connection device.

At block 604, the processor receives a display state signal of a display state of the electronic device via a sensor. The display state of the electronic device can be a portrait display state (FIG. 3) or a landscape display state (FIG. 4).

At block 606, the processor adjusts properties (for example, size or direction) of a first image according to the display parameters of the display device and the display state of the electronic device.

At block 608, the processor determines whether the electronic device operates in a mirror mode or an extension mode. If the electronic device operates in the mirror mode, the procedure goes to block 610. If the electronic device operates in the extension mode, the procedure goes to block 614. In the illustrated embodiment, the processor receives a voice signal from a user via the microphone, and the work modes of the electronic device can be controlled by the user via the microphone.

At block 610, the processor outputs the first image displayed on the electronic device to the display device.

At block 612, the user can input instructions to the electronic device via a first input device according to a first control signal from the processor module of the processor. For example, if the processor module of the processor receives a first operation signal from a keyboard module, the processor module generates the first control signal, and the user can input the instructions to an input frame of the electronic device via a keyboard of the first input device. If the processor module of the processor receives a second operation signal from a touch module, the processor module generates the first control signal, and the user can input the instructions to the input frame of the electronic device via a touch pad of the first input device. If the processor module of the processor receives a third operation signal from a mouse module, the processor module generates the first control signal, and the user can input the instructions to the input frame of the electronic device via a mouse of the first input device.

At block 614, the processor outputs the first image displayed on the electronic device to the display device, and the processor further outputs a second image to the electronic device.

At block 616, the user can input the instructions to the first image displayed on the display device via the second image (for example, the touch pad interface, the mouse interface, or the keyboard interface) according to a second control signal from the detection module of the processor. Accordingly, the electronic device can be a second input device. For example, if the second image is the touch pad interface, the user can input the instructions to the touch pad interface of the electronic device, the detection module detects a touch signal input by the user via the touch pad interface of the electronic device and transmits the second control signal to the processor module. The processor module receives the second control signal and executes the second control signal. Therefore, the user can input the instructions to the first image displayed on the display device via the touch pad interface according to the second control signal from the detection module of the processor.

The embodiments shown and described above are only examples. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims.

What is claimed is:

1. A display control system for a display device comprising:
a display module configured to generate a first image, wherein the first image is displayed via an electronic device;
a switch module configured to switch to a first switch signal or a second switch signal according to user input instructions, when the switch module switches to the first switch signal, the electronic device operates in a mirror mode, and when the switch module switches to the second switch signal, the electronic device operates in an extension mode; and
a processor module configured to:
receive the switch signal sent from the switch module, when the processor module receives the first switch signal;
output the first image generated from the display module to a display via a display interface;
when the processor module receives the second switch signal, output the first image generated from the display module to the display via the display interface; and
output a second image generated from the display module to a screen via the display interface.

2. The display control system of claim 1, further comprising a detection module, wherein the detection module detects a display state signal transmitted from a sensor, and wherein the processor module further adjusts properties of the first image according to display parameters of the display via the detection module.

3. The display control system of claim 2, wherein the switch module switches to the first switch signal or the second switch signal according to voice signals from the user via a microphone.

4. The display control system of claim 3, further comprising a BLUETOOTH module, wherein a first input device transmits wireless signals can be directly connected to the electronic device via the BLUETOOTH module.

5. The display control system of claim 4, further comprising a keyboard module, when the first input device is a keyboard, the BLUETOOTH module determines whether the wireless signal includes a first instruction signal from the keyboard, if the wireless signal includes the first instruction signal from the keyboard, the BLUETOOTH module outputs the first instruction signal to the keyboard module of the processor, and the keyboard module generates a first operation signal.

6. The display control system of claim 5, further comprising a touch module, when the first the first input device is a touch pad, the BLUETOOTH module determines whether the wireless signal includes a second instruction signal, if the wireless signal includes the second instruction signal, the BLUETOOTH module outputs the second instruction signal to the touch module of the processor, and the touch module generates a second operation signal.

7. The display control system of claim 6, further comprising a mouse module, when the first input device is a mouse, the BLUETOOTH module determines whether the wireless signal includes a third instruction signal from the mouse, if the wireless signal includes the third instruction signal from the mouse, the BLUETOOTH module outputs the third instruction signal to the mouse module of the processor, and the mouse module generates a third operation signal.

8. The display control system of claim 7, wherein the electronic device is coupled to the display and a speaker via the connection device, wherein the electronic device transmits audio signals of the first image and the second image to the speaker of the display device via the audio interface.

9. A display control method for a display device comprising:
connecting to a display device via a connection device;
receiving display parameters of the display device via the connection device;
receiving a display state signal of a display state of an electronic device via a sensor;
adjusting properties of a first image according to the display parameters of the display device and the display state of the electronic device;
determining whether the electronic device operates in a mirror mode, or an extension mode;
outputting the first image displayed on the electronic device to the display device when the electronic device operates in the mirror mode; and
inputting instructions to the electronic device via a first input device according to a first control signal from the processor.

10. The display control method of claim 9, further comprising:
outputting the first image displayed on the electronic device to the display device, and further outputting a second image to the electronic device, when the electronic device operates in the extension mode; and
inputting the instructions to the first image via the second image according to a second control signal from the processor, and the electronic device is a second input device.
